(19) United States
(12) Patent Application Publication
(10) Pub. No.: US 2019/0116546 A1
(43) Pub. Date: Apr. 18, 2019

(54) METHOD FOR NOTIFYING DOWNLINK DATA IN A NETWORK, NETWORK TRIGGERED SERVICE REQUEST METHOD, AND NETWORK ENTITY PERFORMING THE SAME

(71) Applicant: ELECTRONICS AND TELECOMMUNICATIONS RESEARCH INSTITUTE, Daejeon (KR)

(72) Inventors: Yoo Hwa KANG, Daejeon (KR); Dongmyoung KIM, Sejong-si (KR); No Ik PARK, Daejeon (KR)

(21) Appl. No.: 16/161,310

(22) Filed: Oct. 16, 2018

(30) Foreign Application Priority Data
Oct. 17, 2017 (KR) 10-2017-0134856
Sep. 20, 2018 (KR) 10-2018-0113263

(51) Int. Cl. H04W 48/12; H04W 68/02; H04W 8/02; H04W 76/11; H04W 76/27

(52) U.S. Cl. CPC H04W 48/12; H04W 68/02; H04W 48/18; H04W 76/11; H04W 76/27; H04W 8/02

(57) ABSTRACT

A method for notifying downlink data in a network, a network triggered service request method, and a network entity performing the same. The method includes receiving, by an access and mobility management function (AMF), a message including a packet data unit (PDU) session identifier (ID) from a session management function (SMF), confirming, by the AMF, a state of user equipment (UE) associated with the PDU session ID, and transmitting, by the AMF, a non-access stratum (NAS) notification message to the UE through a non-3GPP access if the UE is in a connection management (CM)_IDLE state in 3GPP access and in a CM_CONNECTED state in the non-3GPP access.

### CROSS-REFERENCE TO RELATED APPLICATIONS

This application claims priority to and the benefit of Korean Patent Application Nos. 10-2017-0134856 and 10-2018-0113263 filed in the Korean Intellectual Property Office on Oct. 17, 2017 and Sep. 20, 2018, respectively, the entire contents of which are incorporated herein by reference.

### BACKGROUND OF THE INVENTION

### 1. Field of the Invention

The present invention relates to method for notifying downlink data in a network, a network triggered service request method, and a network entity performing the same.

### 2. Description of Related Art

Recently, standardization of 5G network technology has been underway. In the 3GPP 5G network, downlink data can be transmitted when downlink data of user equipment arrives at a user plane function (UPF), and a user plane connection from the UPF to the user equipment is activated. However, if a packet data unit (PDU) session or a user plane connection is inactivated depending on the state of user equipment, an activation process is required. Through this activation process, the downlink data is announced, which is called a network triggered service request procedure.

### SUMMARY OF THE INVENTION

The present invention has been made in an effort to provide a method for notifying downlink data in a network, and a network entity for performing the same.

The present invention has been made in another effort to provide a method for notifying user equipment through a non-3GPP access for downlink data transmission of a PDU session related to a 3GPP access, and a network entity for performing the same.

According to an exemplary embodiment of the present invention, a method for notifying downlink data in a network is provided. The method may include receiving, by an access and mobility management function (AMF), a message including a packet data unit (PDU) session identifier (ID) from a session management function (SMF), confirming, by the AMF, a state of user equipment (UE) associated with the PDU session ID, and transmitting, by the AMF, a non-access stratum (NAS) notification message to the UE through non-3GPP access if the UE is in a connection management (CM)_IDLE state in 3GPP access and in a CM_CONNECTED state in the non-3GPP access.

The PDU session ID may be associated with the 3GPP access.

The 3GPP access and the non-3GPP access may be registered in the same public land mobile network (PLMN).

The method may further include performing, by the UE, a UE-triggered service request procedure through the 3GPP access if the UE receives the NAS notification message.

The method may further include transmitting, by a user plane function (UPF), a data notification message to the SMF if the UPF receives downlink data related to a PDU session for the 3GPP access.

The message including the PDU session ID may be a Namf_Communication_N1N2MessageTransfer message.

The method may further include transmitting, by the AMF, a paging message to the 3GPP access if the UE is in a CM_IDLE state in the 3GPP access and in a CM_IDLE state in the non-3GPP access.

According to another exemplary embodiment of the present invention, a network triggered service request method is provided. The method may include transmitting, by a user plane function (UPF), a data notification message to an session management function (SMF) when the UPF receives downlink data related to a packet data unit (PDU) session for 3GPP access, transmitting, by the SMF, a message including an ID of the PDU session to an access and mobility management function (AMF), confirming, by the AMF, a state of user equipment (UE) related to the ID, and transmitting, by the AMF, a non-access stratum (NAS) notification message to the UE through a non-3GPP access if the state of the UE is a connection management (CM)_IDLE state in 3GPP access and a CM_CONNECTED state in the non-3GPP access.

The method may further include performing, by the UE, a UE-triggered service request procedure through the 3GPP access if the UE receives the NAS notification message.

The 3GPP access and the non-3GPP access may be registered in the same public land mobile network (PLMN).

According to another exemplary embodiment of the present invention, an access and mobility management function (AMF), which is a network entity that processes control signals on a network, is provided. The AMF may include a network interface receiving a message including a packet data unit (PDU) session identifier (ID) from a session management function (SMF), and a processor confirming a state of user equipment (UE) associated with the PDU session ID and controlling to transmit a non-access stratum (NAS) notification message to the UE through a non-3GPP access if the UE is in a connection management (CM)_IDLE state in 3GPP access and in a CM_CONNECTED state in the non-3GPP access.

The PDU session ID may be associated with the 3GPP access.

The 3GPP access and the non-3GPP access may be registered in the same public land mobile network (PLMN).

The processor may control to transmit a paging message to the 3GPP access if the UE is in a CM_IDLE state in the 3GPP access and in a CM_IDLE state in the non-3GPP access.

The processor may control to perform user plane reactivation with the UE if the UE is in a CM_CONNECTED state in the 3GPP access.

According to an exemplary embodiment of the present invention, a notification message is transmitted to a non-3GPP access in a connected state instead of performing paging with a 3GPP access for downlink data transmission reaching a network when the UE is in a 3GPP access IDLE state. This may reduce the use of wireless channel resources of the 3GPP access used to perform the paging.

### BRIEF DESCRIPTION OF THE DRAWINGS

FIG. 1 is a diagram illustrating a 5G network according to an exemplary embodiment of the present invention.

FIG. 2 is a flowchart illustrating a method for notifying downlink data in the 5G network.

FIG. 3 is a flowchart illustrating a processing procedure of the AMF 310 according to an exemplary embodiment of the present invention.

FIG. 4 is a diagram illustrating a network entity according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. Throughout the present specification, user equipment (UE) may indicate a terminal, a mobile terminal (MT), a mobile station (MS), an advanced mobile station (AMS), a high reliability mobile station (HR-MS), a subscriber station (SS), a portable subscriber station (PSS), an access terminal (AT), or the like, and may include all or some of the functions of the terminal, the MT, the AMS, the HR-MS, the SS, the PSS, the AT, or the like. In addition, a base station (BS) may indicate an advanced base station (ABS), a high reliability base station (HR-BS), a nodeB, an evolved nodeB (eNodeB), a base transceiver station (BTS), a mobile multihop relay (MMR)-BS, a relay station (RS) serving as a base station, a high reliability relay station (HR-RS) serving as a base station, and the like, and may include all or some of the functions of the base station, the ABS, the nodeB, the eNodeB, the BTS, the MMR-BS, the RS, the HR-RS, and the like.

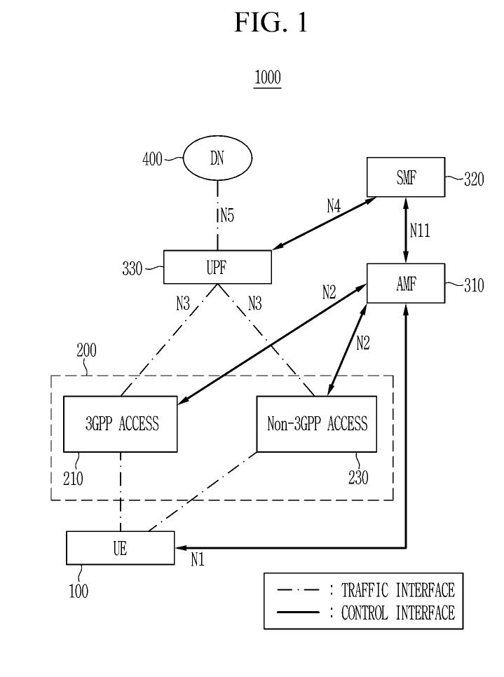

FIG. 1 is a diagram illustrating a 5G network according to an exemplary embodiment of the present invention.

As shown in FIG. 1, a 5G network 1000 according to an exemplary embodiment of the present invention includes UE 100, an access network (AN) 200, an access and mobility management function (AMF) 310, a session management function (SMF) 320, a user plane function (UPF) 330, and a data network (DN) 400.

The UE 100 may access a network through the AN 200. The AN 200 includes a 3GPP access 210 and a non-3GPP access 220. The UE 100 may access a cellular mobile radio access network via the 3GPP access 210. Further, the UE 100 may access a wireless LAN access network via the 3GPP access 210.

The AMF 310 and the SMF 320 are network entities that process control signals. The AMF 310 performs authentication, connection, and mobility control functions. The SMF 320 has a session control function (setting/changing/releasing of a session), and performs a signaling procedure for traffic path setting and traffic mobility management. That is, the SMF 320 controls a data path between the UPF 330 and the AN network 200. The AMF 310 has a non-access stratum (NAS) signal interface N1 together with the UE 100.

The UPF 330 is a network entity of a data plane that integrally accommodates the multiple access networks 210 and 220 via an N3 interface. The UPF 330 connects a data plane between the multiple access networks 210 and 220 and the DN 400 so that traffic of the UE 100 (i.e., the user) can be transmitted and received.

The UPF 330 and the access network 200 receive a routing rule for the UE 100 from the SMF 320 via an N4 or N2 interface, and perform an internet protocol (IP) routing function through the received routing rule.

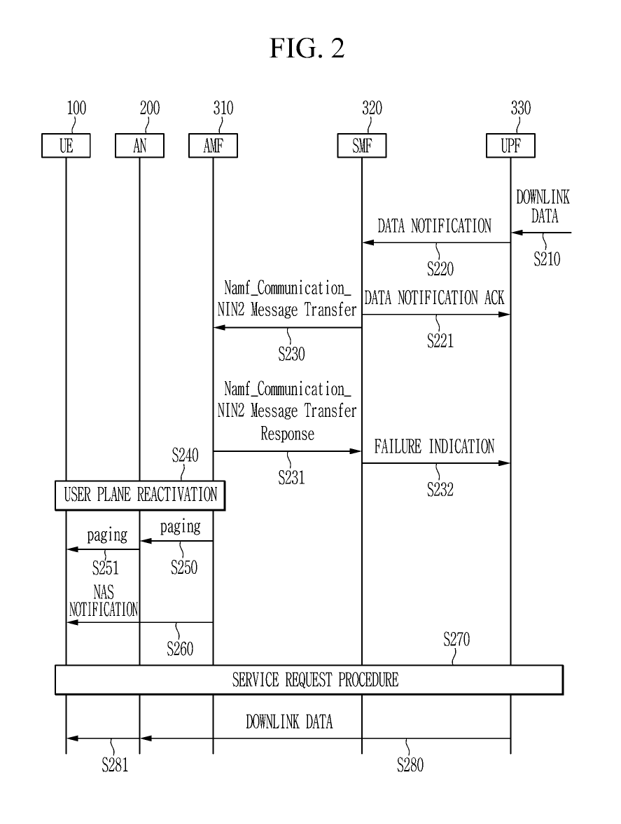

As described above, the 5G network system according to an exemplary embodiment of the present invention is an integrated structure that simultaneously accommodates the 3GPP access 210 and the non-3GPP access 220. In such an integrated structure, when a PDU session or a user plane connection is inactivated depending on a state of the UE, an activation process (i.e., a network triggered service request procedure) is required. Hereinafter, this will be described in detail with reference to FIG. 2.

FIG. 2 is a flowchart illustrating a method for notifying downlink data in the 5G network (i.e., a network triggered service request procedure).

The UPF 330 receives downlink data related to a PDU session for the 3GPP access of the UE 100 from the DN 400 (S210).

When the UPF 330 receives downlink data related to the PDP session for the 3GPP access of the UE 100 in step S210, the UPF 330 transmits a data notification message (S220) to SMF 320.

When the SMF 320 receives the Data Notification message in step S220, the SMF 320 transmits a Data Notification Ack message to the UPF 330 (S221).

The SMF 320 determines an AMF 310 related to the received downlink data and transmits an N11 message including a priority and a PDU session ID to the determined AMF 310 (S230). The SMF 320 transmits a response to the N11 message received in step S230 to the SMF 320 (S231). If the SMF 320 fails to receive the N11 message from the AMF 310, the SMF 320 transmits a failure indication message to the UPF 330 (S232). Here, the N11 message transmitted to the AMF 310 may be

Namf_Communication_N1N2 MessageTransfer, and the response of the N11 message transmitted to the SMF 320 may be Namf_Communication_N1N2 MessageTransfer.

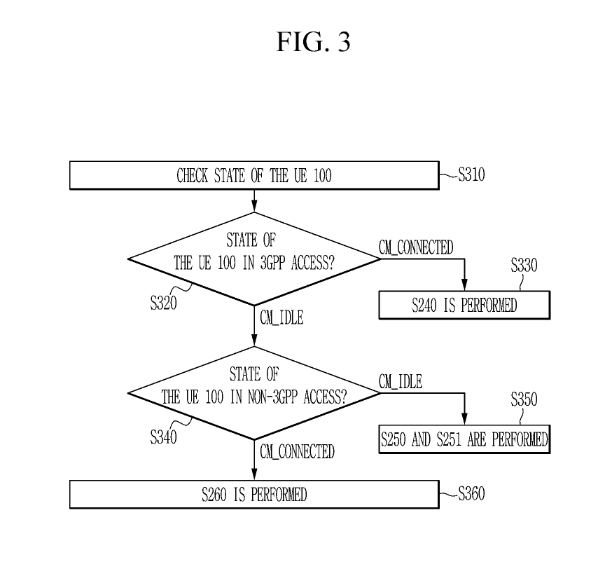

Then, the AMF 310 checks a state of the UE 100 related to the PDU session ID received in step S230. A processing procedure differs according to the state of the UE 100 identified by the AMF 310, which will be described in detail with reference to FIG. 3.

FIG. 3 is a flowchart illustrating a processing procedure of the AMF 310 according to an exemplary embodiment of the present invention.

Referring to FIG. 3, the AMF 310 checks the state of the UE 100 related to the received PDU session ID in step S230 (S310).

When the AMF 310 determines that the UE 100 is in a connection management (CM)_CONNECTED state in the 3GPP access 210 as the state of the UE 100 in the 3GPP access 210, step S240 is performed (S320, S330). When the UE 100 is in the CM_CONNECTED state in the 3GPP access 210, the AMF 310 performs user plane reactivation with the terminal UE through the 3GPP access 210 (S240). That is, the AMF 310 performs a part of a UE Triggered Service Request procedure without transmitting a paging message to a base station (i.e., 3GPP access) or the UE 100, and activates a user plane connection for the PDU session.

When the AMF 310 determines that the UE 100 is in a CM_IDLE state in the 3GPP access 210 and determines a CM_IDLE state in the non-3GPP access 220, steps S250 and S251 are performed (S340, S350). When the UE 100 is in a CM_IDLE state in the 3GPP access 210 and in a CM_IDLE state in the non-3GPP access 220 as well, the AMF 310 transmits a paging message to the 3GPP access 210 and the 3GPP access 210 transmits a paging message to the UE 100 (S250, S251). Accordingly, the UE 100 may perform a UE triggered service request procedure (S270). That is, the AMF 310 initiates communication with the terminal 100 and the base station for paging.

When the AMF 310 determines that the UE 100 is in CM_IDLE state in the 3GPP access 210 and determines CM_CONNECTED state in the non-3GPP access 220, step S260 is performed (S340, S360). When the UE 100 is in the CM_IDLE state in the 3GPP access 210 and in the CM_CONNECTED state in the non-3GPP access 220, the AMF 310 transmits a non-access stratum (NAS) notification message to the UE 100 through the non-3GPP access in the CM_CONNECTED state instead of transmitting the paging message (S260). Through this, a notification about the downlink data may be delivered to the UE. In other words, if the UE 100 is simultaneously registered in the same public land mobile network (PLMN) through 3GPP access and non-3GPP access, and the UE 100 is in a CM_IDLE state for 3GPP access and a CM_CONNECTED state for non-3GPP access, and if the PDU session ID in step S230 is associated with 3GPP access, the AMF 310 transmits a NAS notification message containing the 3GPP access type to the UE 100 through the non-3GPP access.

When the UE 100 receives the NAS notification message in step S260, the UE 100 may initiate a UE triggered service request procedure through 3GPP access (S270). The UE 100 in which the 3GPP access 210 is in CM-IDLE state may perform a service request procedure in response to the NAS notification message to transmit an uplink signaling message or user data. The service request procedure is for the terminal 100 to transmit PDU session information and the AMF 310 to transmit a service response message, thereby the PDU session state between the UE 100 and the network can be managed.

After the service request procedure is performed in step S270, the UPF 330 transmits downlink data to the UE 100 through the access network 200 (S280).

As described above, according to an exemplary embodiment of the present invention, the AMF 310 transmits a notification message for non-3GPP access in a connected state instead of performing paging with 3GPP access for downlink data transmission reaching the network when 3GPP is in an access IDLE state. This may reduce the use of wireless channel resources of 3GPP access used to perform the paging.

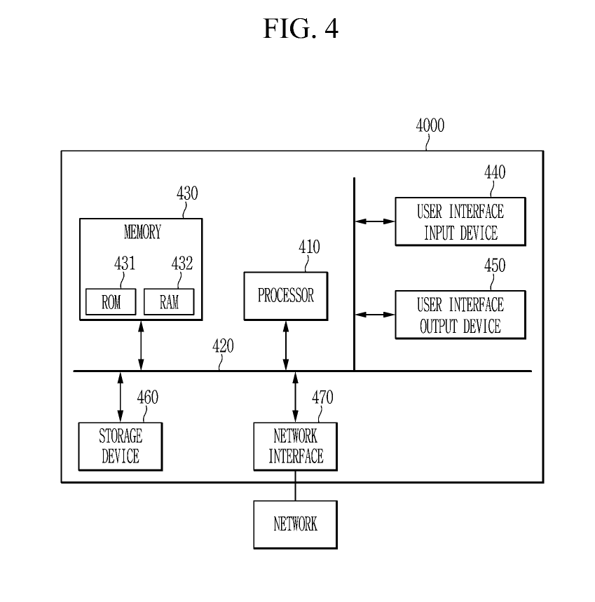

FIG. 4 is a diagram illustrating a network entity according to an exemplary embodiment of the present invention.

The network entity in FIG. 4 may be the AMF 310, the SMF 320, or the UPF 330 of FIG. 1. Such a network entity may be implemented as a computer system, e.g., a computer readable medium.

The computer system 4000 includes at least one of a processor 410, a memory 430, a user interface input device 440, a user interface output device 450, and a storage device 460, that communicate via a bus 420. The computer system 4000 may also include a network interface 470 coupled to a network. The network interface 470 may transmit or receive signals with other entities over the network.

The processor 410 may be a central processing (CPU) or a semiconductor device that executes instructions stored in the memory 430 or the storage device 460. The processor 410 may be configured to implement the functions and methods described in FIG. 1 to FIG. 3.

The memory 430 and the storage device 460 may include various forms of volatile or non-volatile storage media. For example, the memory 430 may include a read only memory (ROM) 431 and a random access memory (RAM) 432. In an exemplary embodiment of the present invention, the memory 430 may be located inside or outside the processor 410, and the memory 430 may be coupled to the processor 410 through various already known means.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for notifying downlink data in a network, the method comprising:
receiving, by an access and mobility management function (AMF), a message including a packet data unit (PDU) session identifier (ID) from a session management function (SMF);
confirming, by the AMF, a state of user equipment (UE) associated with the PDU session ID; and
transmitting, by the AMF, a non-access stratum (NAS) notification message to the UE through non-3GPP access if the UE is in a connection management (CM)_IDLE state in 3GPP access and in a CM_CONNECTED state in the non-3GPP access.

2. The method of claim 1, wherein the PDU session ID is associated with the 3GPP access.

3. The method of claim 1, wherein the 3GPP access and the non-3GPP access are registered in the same public land mobile network (PLMN).

4. The method of claim 1, further comprising performing, by the UE, a UE-triggered service request procedure through the 3GPP access if the UE receives the NAS notification message.

5. The method of claim 1, further comprising transmitting, by a user plane function (UPF), a data notification message to the SMF if the UPF receives downlink data related to a PDU session for the 3GPP access.

6. The method of claim 1, wherein the message including the PDU session ID is a Namf_Communication_N1N2 MessageTransfer message.

7. The method of claim 1, further comprising transmitting, by the AMF, a paging message to the 3GPP access if the UE is in a CM_IDLE state in the 3GPP access and in a CM_IDLE state in the non-3GPP access.

8. A network triggered service request method, the method comprising:
transmitting, by a user plane function (UPF), a data notification message to a session management function (SMF) when the UPF receives downlink data related to a packet data unit (PDU) session for 3GPP access;
transmitting, by the SMF, a message including an ID of the PDU session to an access and mobility management function (AMF);
confirming, by the AMF, a state of user equipment (UE) related to the ID; and
transmitting, by the AMF, a non-access stratum (NAS) notification message to the UE through a non-3GPP access if the state of the UE is a connection management (CM)_IDLE state in 3GPP access and a CM_CONNECTED state in the non-3GPP access.

9. The method of claim 8, further comprising performing, by the UE, a UE-triggered service request procedure through the 3GPP access if the UE receives the NAS notification message.

10. The method of claim 8, wherein the 3GPP access and the non-3GPP access are registered in the same public land mobile network (PLMN).

11. An access and mobility management function (AM F), which is a network entity that processes control signals on a network, the AMF comprising:
a network interface receiving a message including a packet data unit (PDU) session identifier (ID) from a session management function (SMF); and
a processor confirming a state of user equipment (UE) associated with the PDU session ID and controlling to transmit a non-access stratum (NAS) notification message to the UE through a non-3GPP access if the UE is in a connection management (CM)_IDLE state in 3GPP access and in a CM_CONNECTED state in the non-3GPP access.

12. The AMF of claim 11, wherein the PDU session ID is associated with the 3GPP access.

13. The AMF of claim 11, wherein the 3GPP access and the non-3GPP access are registered in the same public land mobile network (PLMN).

14. The AMF of claim 11, wherein the processor controls to transmit a paging message to the 3GPP access if the UE is in a CM_IDLE state in the 3GPP access and in a CM_IDLE state in the non-3GPP access.

15. The AMF of claim 11, wherein the processor controls to perform user plane reactivation with the UE if the UE is in a CM_CONNECTED state in the 3GPP access.
